(19) United States
(12) Patent Application Publication
(10) Pub. No.: US 2024/0173726 A1
(43) Pub. Date: May 30, 2024

(54) METHOD FOR SEPARATING SOLID AND LIQUID PHASES

(71) Applicant: BJARNE CHRISTIAN NIELSEN HOLDING APS, Bevtoft (DK)

(72) Inventor: Bjarne Christian NIELSEN, Bevtoft (DK)

(21) Appl. No.: 18/552,135

(22) PCT Filed: Feb. 17, 2022
(86) PCT No.: PCT/EP2022/053887

§ 371 Date: Sep. 22, 2023

(30) Foreign Application Priority Data
Mar. 24, 2021 (EP) 21164490.1

(51) Int. Cl. B04B 15/12; B04B 7/06; B04B 9/10; B04B 11/04; B04B 13/00

(52) U.S. Cl. CPC B04B 15/12; B04B 7/06; B04B 9/10; B04B 11/043; B04B 13/00; B04B 2013/006

(57) ABSTRACT

A method is provided for controlling separation of solid and liquid phases in a centrifugal basket of a centrifugal. The method includes the steps of monitoring at least associated values of the rotational speed of the centrifugal basket and a purging of the liquid phase from the centrifugal basket, wherein the purging of the liquid phase from the centrifugal basket is monitored using an accelerometer, determining a safe temporal range within which temporal range a wash water can be safely applied to the content of the centrifugal basket, and applying a wash water to the content of the centrifugal basket during at least a portion of the safe temporal range. A computer program product and a centrifugal system are provided for carrying out the method.

### FIELD OF THE INVENTION

The present invention relates to a method for controlling separation of solid and liquid phases in a centrifugal basket of a discontinuous centrifugal. In particular, the present invention relates to a method comprising the step of determining a safe temporal range within which temporal range a wash water be safely applied to the content of the centrifugal basket, and applying a wash water to the content of the centrifugal basket during at least a portion of the safe temporal range. The present invention further relates to a centrifugal system for performing the method.

### BACKGROUND OF THE INVENTION

The following introductory addresses the separation of sugar crystals from mother liquor, only. However, the discussion can be applied generally for other crystallisations.

Separation of sugar crystals from mother liquor is an interesting and challenging subject due to the changing properties of the massecuite (fill mass or slurry, a mixture of crystals and mother liquor coming from the crystallisation vessels).

The quality of a massecuite is defined by the crystal size variation, also designated as coefficient of variation (CV). In a massecuite with a low CV value the crystals have almost the same size. In this case there is plenty of space between the crystals, even when compacted in a centrifugal basket by the strong centrifugal force. This allows the mother liquor between the crystals to escape easily and fast from the basket. In a massecuite with a high CV value the crystals have very different sizes. In this case, the smaller crystals may almost block the cavities between the large crystals, thus impeding the easy purging of the mother liquor. In short, the separation of crystals with a low CV value is fast, while the separation of crystals with a high CV value is slow. Of course, the slow separation process could be compensated by a prolonged centrifugation of the high-CV massecuite, but this would increase the duration of the centrifugation cycle significantly and lead to a significant reduction of the centrifugal's productivity.

Today's technology does not provide operators with information on the varying viscosity of the massecuite. Centrifugal settings are determined and pre-set based on an average massecuite. This results in a separation, that is insufficient for both low-viscosity and high-viscosity massecuites.

During filling a sensor monitors how much massecuite has entered the centrifugal basket. Once the pre-determined filling degree has been reached, the sensor gives a signal to close the inlet valve. This valve is large and takes its time to close, so there will always be a certain extra amount of massecuite entering the centrifugal. This amount is large in the case of low-viscosity massecuite and small in the case of high-viscosity massecuite. The higher the filling degree, the more time is needed to separate the mother liquor from the crystals. This information is not available to the operator, so the centrifugal is quite often not adjusted to give the best separation.

The timing for the addition of wash water has a great impact on the cleaning of the crystals. The mother liquor has a strong adherence to the crystals—even in the case of the strong centrifugal force. A film of mother liquor will remain on the surface of the crystals. To improve the separation, the crystals are washed with water applied through nozzles mounted inside the centrifugal basket. Here again, the standard procedure is to apply the washing according to a pre-set schedule.

For the cases of massecuite with a high CV or a high filling of the basket, the mother liquor will not have left the basket completely when the wash water is applied. When the wash is applied while a significant amount of mother liquor is still in the basket the wash water will be mixed with the mother liquor. Water mixed with the mother liquor has a reduced ability to clean the film of mother liquor from the surface of the crystals. To avoid this, the water should be applied later than a standard setting. For the cases of massecuite with a low CV or a low filling of the basket, the mother liquor will have left the basket before the wash water is applied according to a standard schedule. After the mother liquor has left the layer of crystals in the basket, the open cavities between the crystals allow the strong centrifugal force to send large volumes of air through the crystal layer. The air will dry the film of mother liquor on the crystals. After drying it is much more difficult for the wash water to remove the film of mother liquor, so more water will be required to clean the crystals. To avoid this, the water should be applied earlier than a standard setting

To achieve good separation, it is important to have real-time information about the purging of the mother liquor. As discussed above, starting the wash at the right time is essential to get the best cleaning with the smallest amount of water. Stopping the wash at the right time is equally important.

The addition of wash water at a too high rotational speed of the centrifugal basket reduces the wash water's ability to wash the crystals due to the reduced contact time with the crystals. In addition, when the centrifugal force gets too large relatively to the adhesion of the wash water to the crystal surface, the water will be prevented from flowing to the back side of the crystals and hence the water will wash the front, only.

The above requirements show that the wash water should not be added before a specific time and should stop before the rotational speed of the centrifugal reaches a too high level. The washing should start after the major part of the mother liquor has left the centrifugal basket. If the time needed for application of the necessary amount of wash water is longer than the interval between the required starting and stopping times, then this interval must be prolonged, e.g. by pausing the acceleration of the centrifugal. By following these recommendations, the factory will achieve the optimal washing of the crystals with a given amount of wash water.

The above shows that there seems to be a need for dynamic adjustment of the centrifugal's timing of wash water as this will give many advantages relatively to the fixed timer settings.

It may thus be seen as an object of embodiments of the present invention to provide real-time information relating to purging to adjust the centrifugal settings.

### DESCRIPTION OF THE INVENTION

The above-mentioned object is complied with by providing, in a first aspect, a method for controlling separation of solid and liquid phases in a centrifugal basket of a centrifugal, the method comprising the steps of monitoring at least associated values of the rotational speed of the centrifugal basket and a purging of the liquid phase from the centrifugal basket, wherein the purging of the liquid phase from the centrifugal basket is monitored using an accelerometer, determining a safe temporal range within which temporal range a washing liquid or steam can be safely applied to the content of the centrifugal basket, and applying a washing liquid or steam to the content of the centrifugal basket during at least a portion of the safe temporal range.

Thus, the present invention relates, in a first aspect, to a method for controlling separation of solid and liquid phases in a centrifugal basket of a centrifugal wherein a washing liquid or steam is applied to the content of the centrifugal basket during at least a portion of the safe temporal range.

The method of the present invention is advantageous in that by applying the washing liquid or steam only within the safe temporal range the separation of solid and liquid phases is optimised with respect to the achievable yield of the solid, and with respect to the amount of applied washing liquid or steam. The solid and liquid to be separated may involve that sugar crystals are to be separate from its mother liquor. However, the present invention is also applicable in relation to other types of crystallisation processes.

In the following the washing liquid or steam will be referred to as wash water although it may, in principle, involve any type of appropriate liquid or steam. As it will outlined in further details below the wash water may be applied by spraying nozzles or by other suitable means.

According to the present invention the safe temporal range is adapted to begin when a predetermined condition with respect to at least the purging of the liquid phase from the centrifugal basket is met. The predetermined condition with respect to the purging of the liquid phase from the centrifugal basket may comprise that the purging rate is essentially decreasing over time. An essentially decreasing purging over time will occur after an increased rotational speed of the centrifugal basket has forced a majority of the mother liquor out of the centrifugal basket.

Moreover, the safe temporal range is adapted to terminate when a predetermined condition with respect to at least a rotational speed of the centrifugal basket is met. The predetermined condition with respect to at least the rotational speed of the centrifugal basket may comprise that a certain rotational speed of the centrifugal basket is reached. The certain rotational speed of the centrifugal basket may typically be below 950 rpm, such as around 900 rpm. It should though be noted that these values typically vary for different basket diameters in that the certain rotational speed will decrease for larger basket diameters and vice versa.

The method may further comprise the step of determining the self-induced vibrations of the centrifugal within a predetermined rotational speed range of the centrifugal basket using an accelerometer, and that the purging of the liquid phase from the centrifugal basket is monitored while taking into account the determined self-induced vibrations of the centrifugal.

The predetermined rotational speed range may involve rotational speeds up to 1200 rpm (or even more) of the centrifugal basket. The self-induced vibrations may be determined by rotating an empty centrifugal basket in this predetermined rotational speed range while, at the same time, measuring the vibrations of the centrifugal.

In order to take into account the determined self-induced vibrations of the centrifugal, i.e. remove the influence of the self-induced vibrations, while monitoring the purging of the liquid phase from the centrifugal basket using the accelerometer, the self-induced vibrations may for example be subtracted from the purging signal from the accelerometer. It should though be noted that other techniques may be applied as well.

As it will be discussed in further details below the accelerometer may be positioned or arranged on a stationary part of the centrifugal, such as on an exterior surface portion of a casing at least partly surrounding a centrifugal basket. This positioning of the accelerometer is indeed advantageous in that the accelerometer may then be retrofitted to existing centrifugals.

According to the present invention the rotational speed of the centrifugal basket may, during a portion of the safe temporal range, be maintained at an essentially constant speed over a predetermined time interval in order to extend the duration of the safe temporal range. This predetermined time interval may be in range of seconds, such as up to 20 seconds. Extending the duration of the safe temporal range is advantageous in that it may increase the yield of the separation of solid and liquid phases, and it may reduce the amount of wash water required.

Alternatively, the rotational acceleration of the centrifugal basket may, during a portion of the safe temporal range, be reduced over a predetermined time interval in order to extend the duration of the safe temporal range. Again, this predetermined time interval may be in range of seconds, such as up to 20 seconds. As already addressed, extending the duration of the safe temporal range is advantageous in that it may increase the yield of the separation of solid and liquid phases, and it may reduce the amount of wash water required.

The method may further comprise the step of controlling a first controllable valve configured to separate the purged liquid into an impure amount (green run-off) when in a first position, and a pure amount (white run-off) when in a second position. According to the present invention the first controllable valve is switched from the first position to the second position when a predetermined amount of wash water has been applied to the content of the centrifugal basket. The predetermined amount of wash water may be a certain percentage of the total amount of wash water to be applied to the content of the centrifugal basket. The separation of the impure amount (green run-off) from the pure amount (white run-off) is indeed advantageous in that the further processing of the pure amount (white run-off) then becomes significantly simpler. The first controllable valve should preferably switch from the first position to the second position at a point in time which is optimal with respect to separating the green run-off from the white run-off.

Thus, according to the present invention the safe temporal range may be extended or shortened by varying the rotation speed of the centrifugal basket so that an optimal separation of the solid and liquid phases is achieved using a predetermined amount of washing liquid or steam, i.e. wash water. The predetermined amount of washing liquid or steam may be set at an absolute minimum for costs and environmental reasons. Alternatively, or in combination therewith, the safe temporal range may be extended or shortened by varying the rotation speed of the centrifugal basket so that a predetermined separation of the solid and liquid phases is achieved using the smallest amount of washing liquid or steam, i.e. wash water. The predetermined separation may reflect a desired yield to be reached.

The method may further comprise a safety procedure comprising the step of reducing the rotational speed of the centrifugal basket if the purging of the liquid phase from the centrifugal basket does not show a decreasing behaviour when the rotational speed of the centrifugal basket has reached a predetermined value. The predetermined value may be 500 rpm. It should though be noted that this predetermined rpm value may vary for different centrifugal installations. If the purging of the liquid phase from the centrifugal basket does not show a decreasing behaviour the centrifugal basket may, for safety reasons, be brought to a standstill.

The method may further comprise the step of preventing the application of washing liquid or steam, until the purging of the liquid phase from the centrifugal basket shows a decreasing behaviour. A decreasing purging behaviour signals to the operator that the layer of crystals in the centrifugal basket has open channels between the crystals through which channels viscous liquid may be purged. Adding wash liquids, such as wash water, after a decrease of the purging will thus be safe. Thus, according to the present invention a decreasing purging signal can advantageous be used to release a safe application of washing liquid.

In a second aspect, the present invention relates to a computer program product for carrying out the method according to the first aspect when said computer program product is run on a computer or run on a microprocessor. The computer or microprocessor may form part of a control unit of the centrifugal either on site or remote.

In a third aspect, the present invention relates to a centrifugal system for separation of solid and liquid phases, the centrifugal system comprising a centrifugal casing surrounding a centrifugal basket, wherein a purged liquid from the centrifugal basket hits an interior surface portion of the centrifugal casing, and wherein an accelerometer is secured to said centrifugal casing, and wherein the centrifugal system further comprises a control unit for performing the method according to the first aspect.

In a fourth aspect, the present invention relates to a safety procedure method for controlling a centrifugal basket of a centrifugal for separation of solid and liquid phases, the method comprising the steps of monitoring at least associated values of the rotational speed of the centrifugal basket and a purging of the liquid phase from the centrifugal basket, and reducing the rotational speed of the centrifugal basket if the purging of the liquid phase from the centrifugal basket does not show a decreasing behaviour when the rotational speed of the centrifugal basket has reached a predetermined value, or

monitoring at least associated values of the rotational speed of the centrifugal basket and a purging of the liquid phase from the centrifugal basket, and reducing the rotational speed of the centrifugal basket if the purging of the liquid phase from the centrifugal basket has not reached a predetermined purging value when the rotational speed of the centrifugal basket has reached a predetermined value.

The safety procedure method is advantageous in that it prevents that free liquid inside the centrifugal basket potentially form waves and cause an uneven distribution of liquid around the centrifugal basket, resulting in undesired basket vibrations. With vibrations at low rotational speeds the centrifugal basket may easily be stopped, but at higher rotational speeds the vibrations develop so fast that the centrifugal may destroy itself, having potentially fatal consequences for the operators of the centrifugal.

The purging of the liquid phase from the centrifugal basket may be monitored using an accelerometer. The term predetermined purging value is to be understood as an amount of liquid, such as weight or volume, leaving the centrifugal basket. The predetermined purging value may be per time unit, such as per second, or it may be an accumulated value.

The predetermined value of the rotational speed of the centrifugal basket is around 500 rpm. It should though be noted that this predetermined rpm value may vary for different centrifugal installations. If the purging of the liquid phase from the centrifugal basket does not show a decreasing behaviour, of if the purging of the liquid phase from the centrifugal basket has not reached a predetermined purging value when the rotational speed of the centrifugal basket has reached a predetermined value the centrifugal basket may, for safety reasons, be brought to a standstill. Thus, the step of reducing the rotational speed of the centrifugal basket may comprise that the centrifugal basket is brought to a standstill.

In a fifth aspect the present invention relates to a computer program product for carrying out the method according to the fourth aspect when said computer program product is run on a computer or run on a microprocessor. The computer or microprocessor may form part of a control unit of the centrifugal either on site or remote.

In a sixth aspect the present invention relates to a centrifugal system for separation of solid and liquid phases, the centrifugal system comprising a centrifugal casing surrounding a centrifugal basket, wherein a purged liquid from the centrifugal basket hits an interior surface portion of the centrifugal casing, and wherein an accelerometer is secured to said centrifugal casing, and wherein the centrifugal system further comprises a control unit for performing the method according to the fourth aspect.

In general, the various aspects of the present invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

The present invention will now be described in further details with reference to the accompanying figures where

FIG. 1 shows a cross-sectional view of a centrifugal for use in relation to the present invention,

FIG. 2 shows typical information given by the purging sensor,

FIG. 3 shows a recommended wash water interval (dotted region) for wash water start at 26 seconds after end of filling, and an intermediate spinning of 9 seconds,

FIG. 4 shows a wash water start at 20 seconds and no intermediate spinning,

FIG. 5 shows a wash water start at 23 seconds and no intermediate spinning,

FIG. 6 shows a wash water start at 26 seconds and no intermediate spinning,

FIG. 7 shows a wash water start at 26 seconds and 3 seconds intermediate spinning,

FIG. 8 shows a wash water start at 26 seconds and 6 seconds intermediate spinning,

FIG. 9 shows a wash water start at 26 seconds and no intermediate spinning,

FIG. 10 shows a wash water start at 26 seconds and 3 seconds intermediate spinning,

FIG. 11 shows a wash water start at 26 seconds and 6 seconds intermediate spinning,

FIG. 12 shows a wash water start at 26 seconds and 9 seconds intermediate spinning,

FIG. 13 shows a wash water start at 26 seconds and 12 seconds intermediate spinning,

FIG. 14 shows the sugar colour at different intermediate spinning intervals,

FIG. 15 shows the ash content at different intermediate spinning intervals,

FIG. 16 shows a wash water start at 20 seconds and no intermediate spinning,

FIG. 17 shows a wash water start at 23 seconds and 3 seconds intermediate spinning,

FIG. 18 shows a wash water start at 26 seconds and 6 seconds intermediate spinning,

FIG. 19 shows a wash water start at 29 seconds and 9 seconds intermediate spinning,

FIG. 20 shows the sugar colour at different starting times of the spray water interval,

FIG. 21 shows an observation panel,

FIG. 22 shows an observation panel after changing the start of washing from 20 seconds to 23 seconds, and

FIG. 23 shows an observation panel after changing the start of washing from 23 seconds to 26 seconds.

### DETAILED DESCRIPTION OF THE INVENTION

In general, the present invention relates to a method for controlling a process in a centrifugal. This process may involve separation of solid and liquid phases, such as separation of solid crystalline sugar and liquid syrup in a centrifugal. The present invention further relates to a centrifugal for separating solid and liquid phases by monitoring a purging liquid from a centrifugal basket and use this information to control an appliance of wash water to be added to the content inside the centrifugal basket.

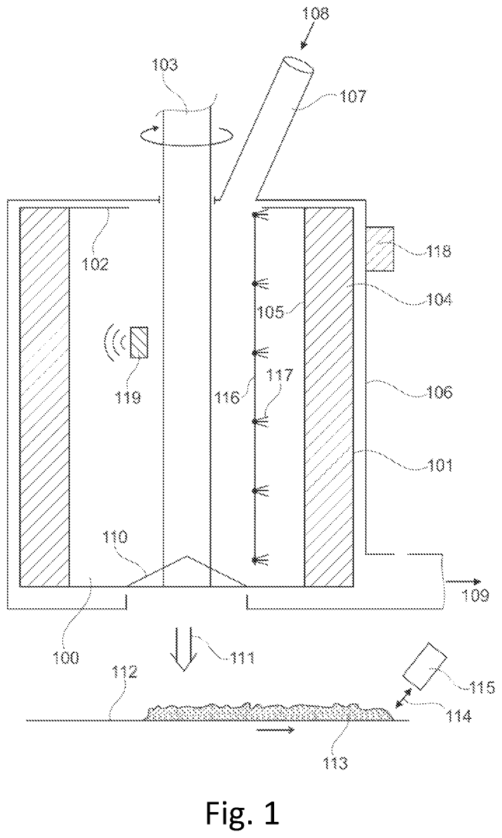

In term of instrumentation a sensitive accelerometer is capable of detecting the vibrations coming from drops of mother liquor hitting the outer wall of the centrifugal. As there are many other self-induced vibrations in the centrifugal, a comprehensive analysis of frequencies and signal processing is required to get a good and clear representation of the purging of the mother liquor. The accelerometer is arranged on a stationary part of the centrifugal, such as on an exterior surface portion of a casing at least partly surrounding a centrifugal basket, cf. FIG. 1. The positioning of the accelerometer is advantageous in that the accelerometer may be retrofitted to existing centrifugals.

As it will be disclosed in further details below a plot of the amount of purging updated over the duration of the centrifugal cycle provides a tool for the control of the centrifugal. The plot will show when to start the wash water: When the major part of the mother liquor has been purged and the purging signal is decreasing.

By adding the rotational speed to the plot, it can automatically show when the rotational speed for stopping the wash is reached. Adding the actual setting for the application of the wash water, the plot will tell the operator whether the actual spraying complies with the suggested optimal spraying or not. With this information the operator can shift the actual water application and extend or shorten the duration of the optimal interval for water application by modifying the pause in the acceleration. These adjustments can be made automatically by a computer, too.

Moreover, many beet sugar factories and sugar refineries separate the run-off purged from the centrifugal. The run-off from the mother liquor (low purity run-off) containing a great amount of (non-sugar) impurities is sent via a valve to one vessel, while the run-off from the water wash (high purity run-off) containing a minimum of impurities is sent to another vessel. This prevents a re-mixing of the run-off streams already separated into two parts containing a low and a high amount of non-sugars. The plot of the centrifugal cycle mentioned above will show when each of the two streams are discharged from the centrifugal, thus allowing the valve to be shifted automatically for optimum separation.

In view of the above remarks the present invention thus comprises:
1) The above signal analysis and processing to convert the vibration signal to information on the purging.
2) A real-time graphical presentation of optimum interval for wash water application compared with the actual wash water settings of the centrifugal.
3) Indication of a necessary delay, if any, of the centrifugal acceleration in order to avoid a too high rotational speed during washing.
4) Indication of the optimum timing for the shift from low purity to high purity run-off.
5) Combining the information mentioned above with a real-time measurement of the sugar colour to control the amount of wash water applied, so it is large enough to prevent the colour from exceeding the quality limit and small enough to keep the factory losses and costs in check.

Referring now to FIG. 1 a cross-sectional view of a centrifugal for use in connection with the present invention is depicted. The centrifugal shown in FIG. 1 comprises a rotatably mounted centrifugal basket 100 in a batch centrifugal being configured to rotate around shaft 103 with a controllable speed of rotation. The drive unit for rotating the centrifugal basket 100 is not shown.

The centrifugal contains a feeding arrangement 107 for feeding fill-mass into the centrifugal basket 100 as indicated by arrow 108. Upon rotation of the batch centrifugal basket 100 the fill-mass entering through pipe 107 will be pressed as a layer 104 against the vertical sidewall 101 of the centrifugal basket 100. As liquid, such as syrup, is allowed to penetrate or escape through pinholes in the vertical sidewall 101 upon rotation of the centrifugal basket 100, separation of solid and liquid phases may be provided. The liquid penetrating or escaping the centrifugal sidewall 101 is collected by the outer housing 106 and led to the outlet channel 112 where it leaves the centrifugal as indicated by arrow 109.

After separation from the liquid phase the solid phase leaves the centrifugal basket 100 via the valve 110 in the bottom of the centrifugal basket 100 as indicated by arrow 111. Upon leaving the centrifugal basket 100 the solid phase 113 falls onto a conveyer arrangement 112 as indicated by the horizontal arrow. A colour sensor 115 may measure the colour of the solid phase 113 via optical reflections as indicated by the arrow 114 for monitoring the sugar quality and optimising the amount of wash water.

An arrangement for removing the solid phase from the inner sidewalls of the centrifugal basket is also provided. This is not shown in FIG. 1. An edge 102 ensures that the fill-mass is maintained inside the centrifugal basket 100.

During rotation of the centrifugal basket 100, the fill-mass 104 forms an inner surface 105. A sensor arrangement 119, such as an optical triangulation arrangement, a radar or a ultrasound sensor, may be provided for determining a filling rate as well as a filling level of the centrifugal basket 100.

A sensor 118 in the form of an accelerometer is arranged on an exterior surface portion of the outer casing 106. During rotation of the centrifugal basket 100 purging liquid penetrates through the basket wall 101 before hitting the inner side of the outer casing 106. When hitting the inner side of the outer casing 106 vibrations are induced in the casing. At least part of these vibrations may be detected by one or more accelerometers 118 arranged on the exterior surface portion of the outer casing 106. In FIG. 1 a single accelerometer 118 is depicted as being secured to an upper portion of the outer casing 106. It should however be noted, that the accelerometer 118 may alternatively be secured to other portions of the outer casing 106, such as a middle portion, a lower portion etc. Moreover, additional accelerometers 118 may be secured to the outer casing 106. In case a plurality of accelerometers 118 are secured to the outer casing 106 these accelerometers may be distributed around the outer casing 106 in any pattern, such as being distributed evenly around the outer casing 106. The plurality of accelerometers 118 may be of the same type or they may be different types of accelerometers.

As it will be discussed in further details below the detected vibration signal is analysed in order to provide information about the status of the separation of the solid and liquid phases. More particularly, the detected vibration signal is used to control the timing of an amount of wash water to be added to the fill-mass via the washing arrangement 116. A control unit (not shown) may be used to analyse the detected signal or detected signals from one or more accelerometers as well as to control the appliance of wash water added to the fill-mass via the washing arrangement 116.

As depicted in FIG. 1 the washing arrangement 116 has a plurality of nozzles 117 so that a homogeneous washing of the fill-mass 104 across the surface 105 may be provided.

According to the present invention the information derived from the accelerometer 118 may be used to
1) determine the time, when washing liquid may be safely applied,
2) determine whether a fill-mass has so bad purging properties it should be sent to re-dissolution and re-crystallisation,
3) initiate washing of the fill-mass,
4) alter the amount of wash water added to the fill-mass, and
5) terminate washing of the fill-mass.

In general, the washing of the surface 105 may be initiated when the liquid phase of the fill-mass leaves the surface 105. If too much wash water is applied too fast to the surface 105, an undesired liquid layer will form on the surface 105. This should be avoided as such a liquid layer may generate waves and thereby instability within the centrifugal basket 100 upon rotation thereof. A liquid layer may be formed due to for example a slowly moving liquid phase (towards the centrifugal basket wall 101) or due to packing of the solid phase near the centrifugal basket wall 101.

A swirling fill-mass or liquid layer inside the centrifugal basket 100 may bring the centrifugal basket 100 out of balance. As the combined weight of the fill-mass and the rotating centrifugal basket 100 of the centrifugal is several tons such an unbalanced situation should be avoided.

The first portion of the purged liquid phase/syrup from a batch of fill-mass typically contains a large amount of impurities. According to the present invention it is possible to determine when this first portion of contaminated syrup has left the fill-mass 104 using information from the accelerometer 118. At this point in time the wash water may be activated and the resulting second portion of purged liquid phase (washing syrup) is much cleaner than the first portion. It is therefore highly desirable to keep the first and second portions of syrup separated. This may be achieved via a valve (not shown) positioned near the outlet channel 112 so that the first portion of syrup follows a first route, whereas the second portion of syrup follows a second and different route.

Thus, the present invention relates to a method for controlling separation of solid and liquid phases in a centrifugal. In particular, the present invention relates to a method for controlling an appliance of wash water to be added to a fill-mass inside a centrifugal basket in response to a measured vibration signal. A more detailed discussion of the appliance of the wash water in an optimal manner will be provided in the following.

According to the method of the present invention the signal from the vibration/purging sensor 118 in FIG. 1 can be used to control a centrifugal to safely produce an optimum sugar quality. The control of the centrifugal may be performed from a control room in the sugar factory. As already disclosed the purging sensor 118 measures the syrup flow inside the centrifugal once it has passed the centrifugal basket wall 101. By receiving signals from the centrifugal, the information relating to the filling of the centrifugal basket, the start and the end of the safe and optimum spraying intervals, as well as the position of shifting the run-off valve may be visualised.

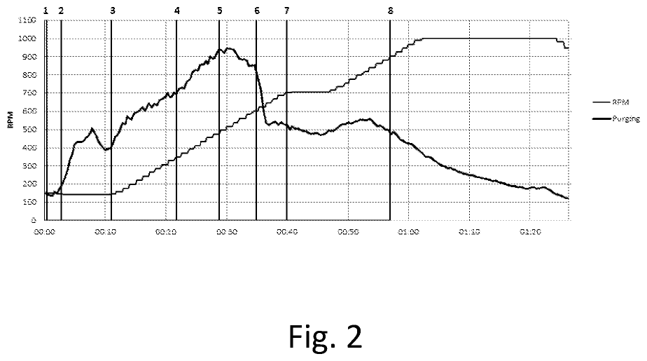

Turning now to FIG. 2 a typical purging curve is shown for illustrative purposes—FIG. 2 also shows the rotational speed of the centrifugal basket. The vertical lines 1 through 8 in FIG. 2 indicate the following general events:
1) Just where the graph begins, the valve for fill mass is opened. This is the starting signal for a new cycle.
2) The second vertical indicates that the valve for run-off changes from white (high purity) to green (low purity).
3) At the third vertical line the rpm curve breaks and starts to increase. It indicates that the fill mass valve is closing.
4) At the fourth vertical line (just 10 seconds later) the washing with syrup is initiated.
5) At the fifth vertical line (about 6 seconds later) the washing with syrup stops.
6) At the sixth vertical line (after another 4 seconds) the washing with water is initiated.
7) At the seventh vertical line the valve for the run-off changes from green (low purity) to white (high purity).
8) At the eighth and final vertical line the washing with water stops.

The fill-mass delivered into the basket 100 has a solid phase (the crystals) and a liquid phase (the mother liquor). Additional liquid for washing is added later. In particular, the additional liquid will always involve wash water, but it may also involve wash syrup. The liquid phase will, during rotation of the centrifugal basket 100, cause or exercise a pressure on the part of the liquid just inside the vertical part 101 of the centrifugal basket 100. At increasing rotational speeds of the centrifugal basket 100, this pressure increases and leads to increased purging and consequently an increased purging signal. The increasing purging signal is seen in FIG. 2 where the purging signal reaches its maximum level after 30 seconds where the rotational speed of the centrifugal basket 100 is around 500 rpm.

When a significant part of the liquid has left the centrifugal basket 100, the exercised pressure will decrease which causes the purging signal to decrease as also seen in FIG. 2 although the rotational speed of the centrifugal basket 100 still increases.

A decreasing purging signal during continued acceleration of the centrifugal basket 100 thus signals to the operator that a significant part of the liquid has been purged from the basket. When this occurs within a predetermined interval after the start of acceleration, then the layer of crystals 104, cf. FIG. 1, has open channels between the crystals. These open channels allow the viscous liquid to be purged. The liquids added later will have an even lower viscosity and can easily be purged through the already open channels. Adding wash liquids at a moderate rate after a decrease of the purging signal will thus be safe.

On the other hand, a long delay before the purging signal decreases, signals to the operator that the fill-mass is difficult to separate. If the fill-mass is difficult to separate, free liquid may potentially built-up inside the layer of crystals 104 on the vertical part 101 of the centrifugal basket 100. Such free liquid may potentially form waves and cause an uneven distribution of liquid around the centrifugal basket 100, resulting in undesired basket vibrations. With vibrations at low rotational speeds the centrifugal basket 100 may easily be stopped, but at higher rotational speeds the vibrations develop so fast that the centrifugal may destroy itself, having potentially fatal consequences for the operators of the centrifugal.

Thus, according to the present invention a decreasing purging signal can advantageous be used to release a safe application of washing liquid, whereas an extended delay of the decrease in the purging signal can be used to safely stop the centrifugal basket and send the fill-mass to re-dissolution and re-crystallisation.

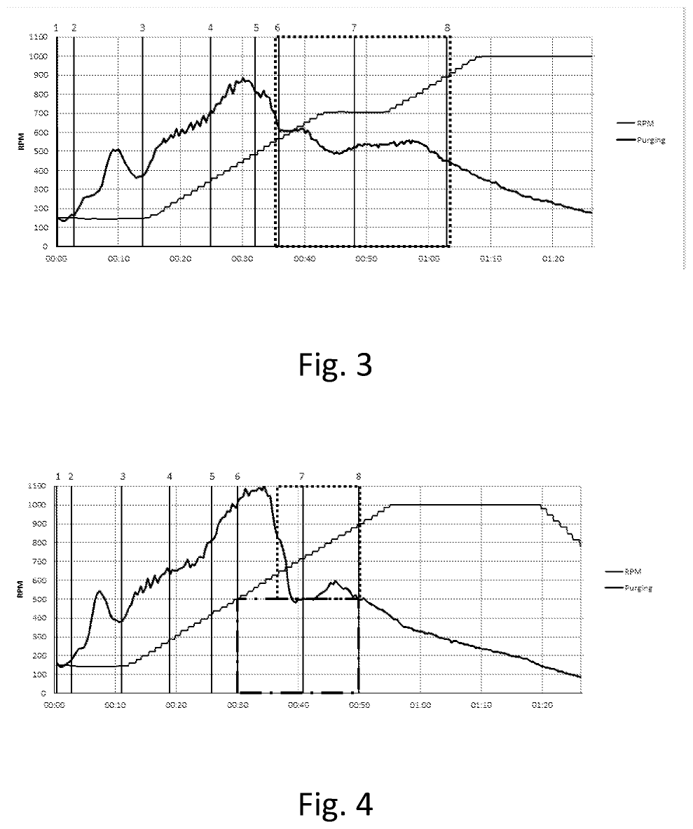

Referring now to FIG. 3, in order to receive the best sugar quality while using a minimum amount of wash water it is important to start the wash water addition at the right time and to end the wash water addition before the centrifugal basket has reached its maximum speed. Based on the analysis of ash content and colour in various tests, the best time to start the wash water addition would be the moment, when the first peak of the purge has finished, and the purging curve is on its downslope. The addition of wash water should be finished close to a centrifugal speed of 900 rpm. In FIG. 2 the optimum interval for the wash water addition is indicated as the hatched region.

Whenever the wash water addition happens within this interval, the result for the sugar colour and ash content will (as shown below) be lower than in the cases in which the water addition starts earlier or ends later.

The operator of the centrifugal has the following two options to optimize the start and the end of the wash water addition:
1) The option to set the right start point of the spraying interval is to change the time gap between the end of filling of the centrifugal basket and the beginning of the wash water addition.
2) The option to stop the wash water addition at the right rotational speed of the centrifugal basket is to change the timer for intermediate spinning.

The purging sensor will provide information illustrating the actual wash water interval (dashed region) in relation to the ideal wash water interval (dotted region). With this information the operator can trim the centrifugal without being on site.

FIG. 4 shows a purging curve for a centrifugal batch in which the syrup layer started at a speed of 300 rpm. Due to the early start of the syrup layer the wash water starts (at the sixth vertical line) just 20 seconds after the end of the centrifugal filling which is far too early in relation to the optimum wash interval (dotted region). In order to start the wash water at the right time the operator, or the system itself, has the option either to start the syrup layer later or to increase the time gap between the end of the syrup layer and the start of the wash water.

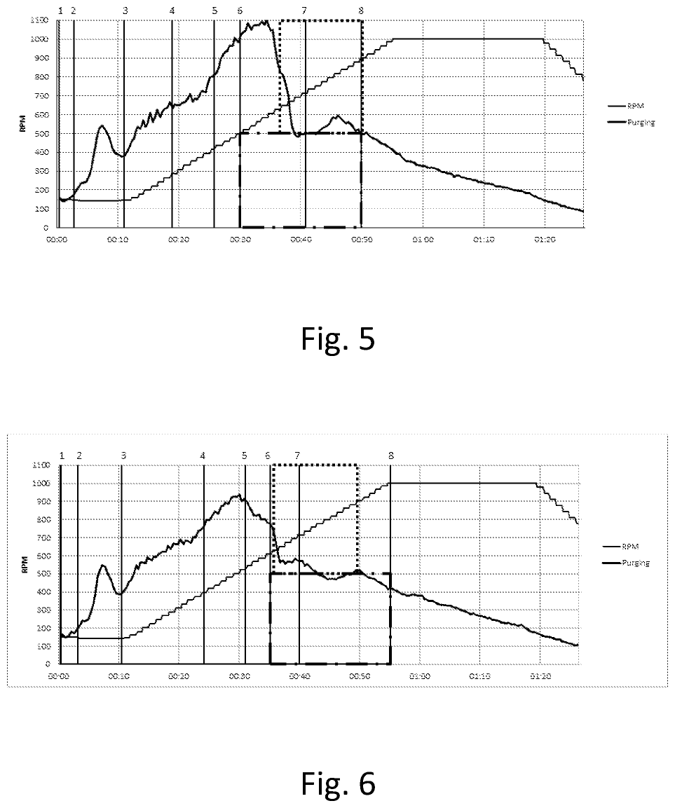

FIG. 5 shows the purging curve for a strike in which the start of the syrup layer has been delayed by 3 seconds. The syrup spray now starts at 350 rpm and the wash water addition starts 23 seconds after the end of the centrifugal filling. The actual wash water interval still starts too early (dashed region), and it also ends at a higher centrifugal speed than recommended (dotted region).

To start the purging at the right time the syrup layer was changed by another 3 seconds. As seen in FIG. 6 it now starts at a centrifugal speed of 400 rpm. By doing this change the wash water addition now starts at the right time but it ends at a centrifugal speed of 1000 rpm (dashed region) which is above the suggested maximum of 900 rpm (dotted region).

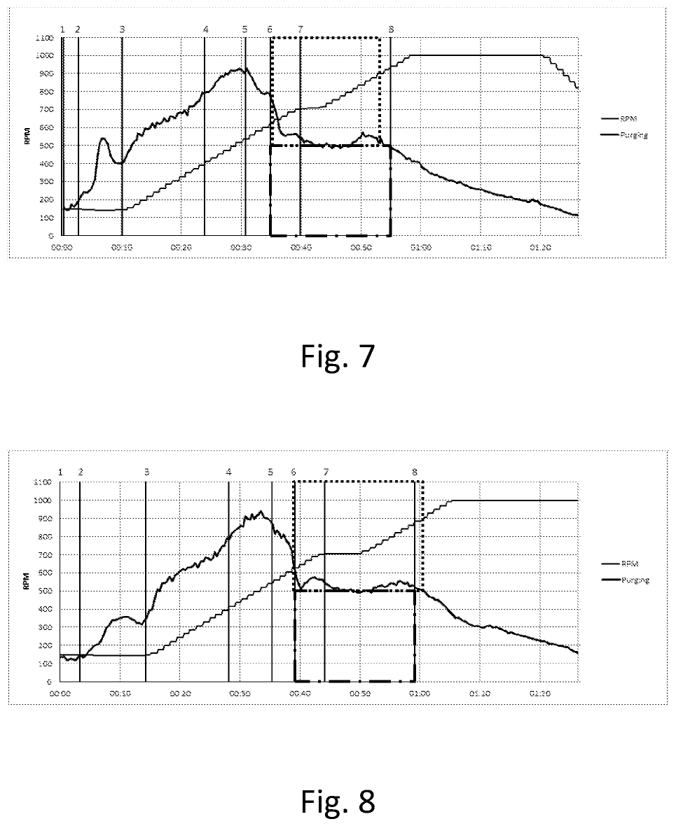

To adjust the end of the wash water interval the operator, or the system itself, has the possibility to stop the increase of the centrifugal speed for a while by incorporating an intermediate spinning interval. During this interval the centrifugal keeps the speed constant, and therefore it reaches its maximum speed later, cf. the plateau in FIG. 7. FIG. 7 also shows the purging curve for a syrup layer at 400 rpm and an intermediate spinning interval of 3 seconds. Now the actual wash water interval corresponds almost to the suggested profile. Only the end of the wash water interval is coming a couple of seconds later than recommended. This is seen as the small difference between the end points of the dashed region and the dotted region.

By increasing the intermediate spinning time to 6 seconds the purging profile matches the recommended spraying interval, cf. FIG. 8). The centrifugal has thus now been trimmed without anyone being on site to look into the centrifugal.

The above-mentioned trim procedure may be implemented using a control algorithm so that the centrifugal is configured to trim the operation of the centrifugal, and thus controlling the separation of solid and liquid phases, in an automatic manner.

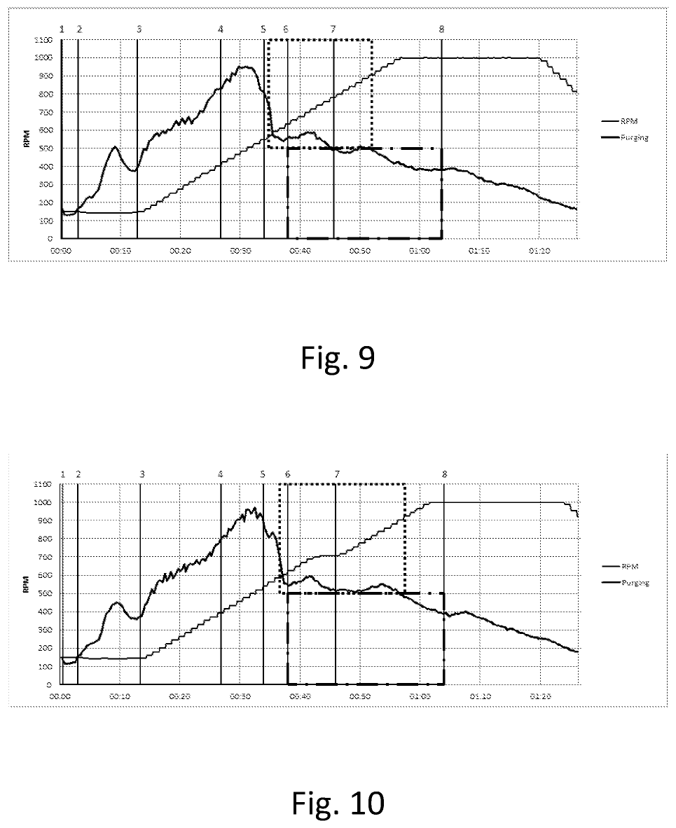

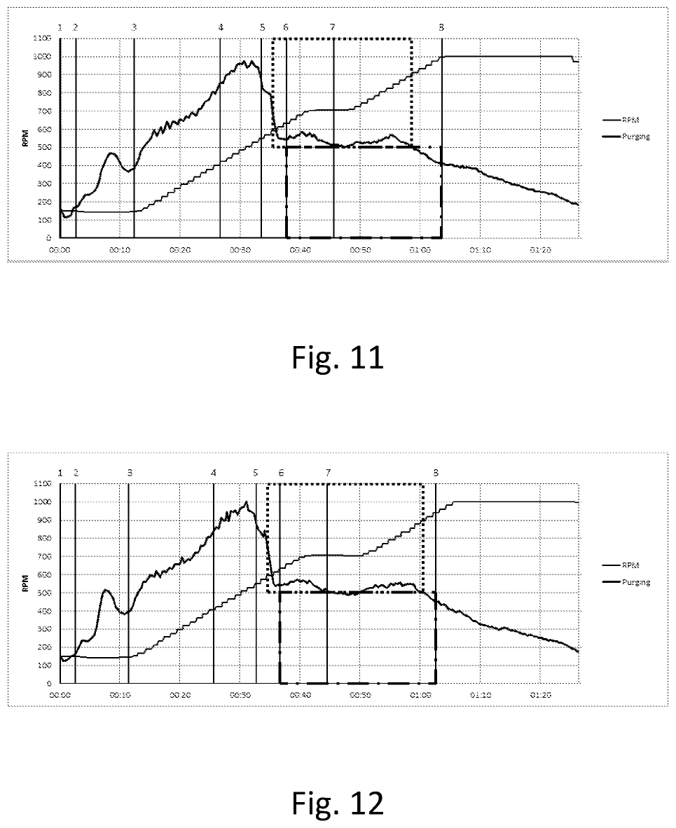

The influence of the intermediate spinning of the centrifugal basket on the sugar quality has been investigated. Referring now to FIGS. 9-13 the purging situation for a test series in which the wash water was started 26 seconds (at the fifth vertical line) after the finishing of the filling of the centrifugal is shown. As seen in FIG. 9 the wash water interval ends far too late if no intermediate spinning is present.

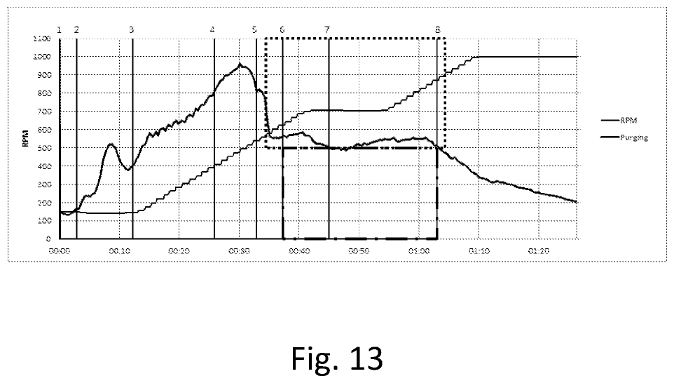

By increasing the intermediate spinning time in steps of 3 seconds, cf. FIGS. 10-13, the actual wash water interval (dashed region) finally reached the suggested optimum at an intermediate spinning time of 12 seconds, cf. FIG. 13.

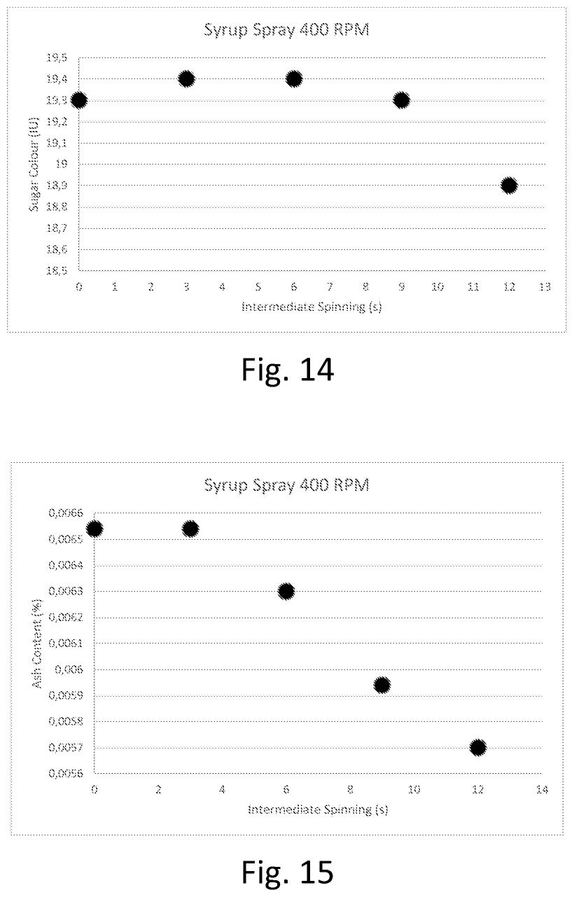

FIGS. 14 and 15 show the sugar colour and the ash content for the different intermediate spinning times. Both curves show the best sugar quality with a constant amount of wash water when the actual spraying interval matched the suggested optimum.

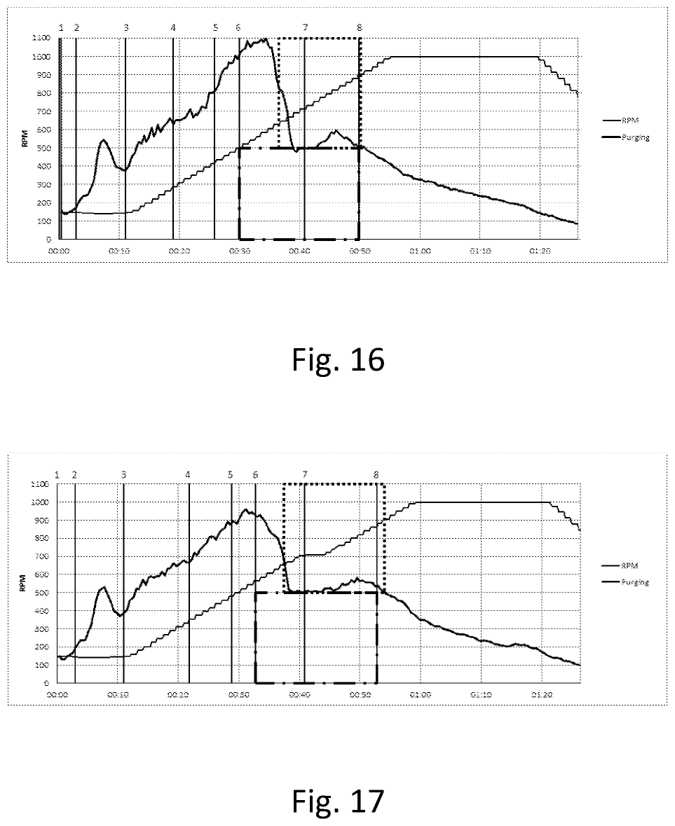

Optimizing the sugar quality by adjusting the washing start and intermediate spinning duration has also been investigated. FIGS. 16-19 show the purging situation for a test series in which 1) the wash water was started at different times, while 2) the end of the washing interval ended close to the recommended centrifugal speed. Starting the wash water 20 seconds after the end of the centrifugal filling, without intermediate spinning, results in an actual washing interval (dashed region) which starts much earlier than recommended (dotted region) and ends at the recommended centrifugal speed, cf. FIG. 16.

Increasing the start time for the wash water and the intermediate spinning time in steps of 3 seconds, shifts the actual washing interval closer to the recommended ideal interval, cf. FIGS. 17-18.

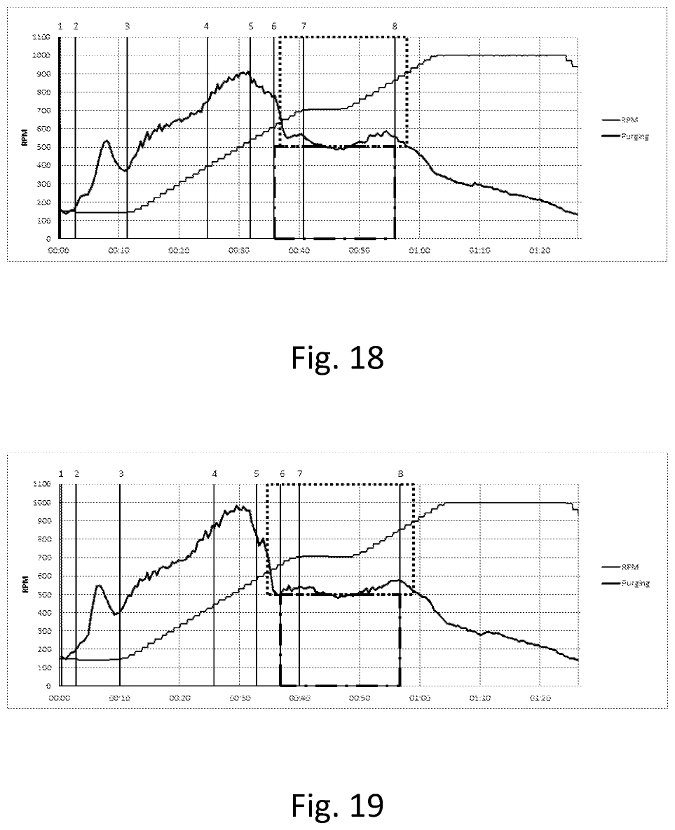

When the wash water starts 29 seconds after the end of filling the centrifugal and the intermediate spinning time is set to 9 seconds, the actual washing interval (dashed region) is well inside the recommended washing interval (dotted region), cf. FIG. 19.

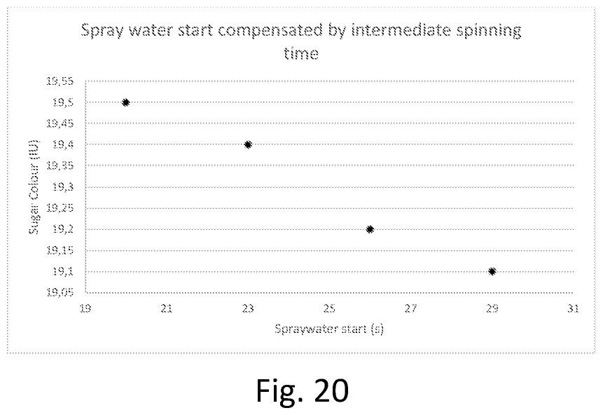

FIG. 20 shows how the sugar colour decreases, while the actual washing interval is getting closer to the recommended interval.

The present invention also aims at controlling molasses losses and run-off purities from the centrifugal basket. Changing the centrifugal timers will not only have an influence on the sugar quality delivered in each batch—it will also have a significant influence on the run-off purities. For a sugar factory with a daily processing capacity of 10.000 of beets, a small change (of for example 1 second) on the wash water interval can cause several tons of sugar in molasses losses every day. Therefore, it is important to understand the influence of the changes made by the operator, not only on the sugar quality but also on the run-offs as well as on the sugar balance.

The present invention provides a simple tool which allows the operator to use an off-line model to simulate and evaluate the influences of the changes of the centrifugal timers on the most important process parameters during centrifugation.

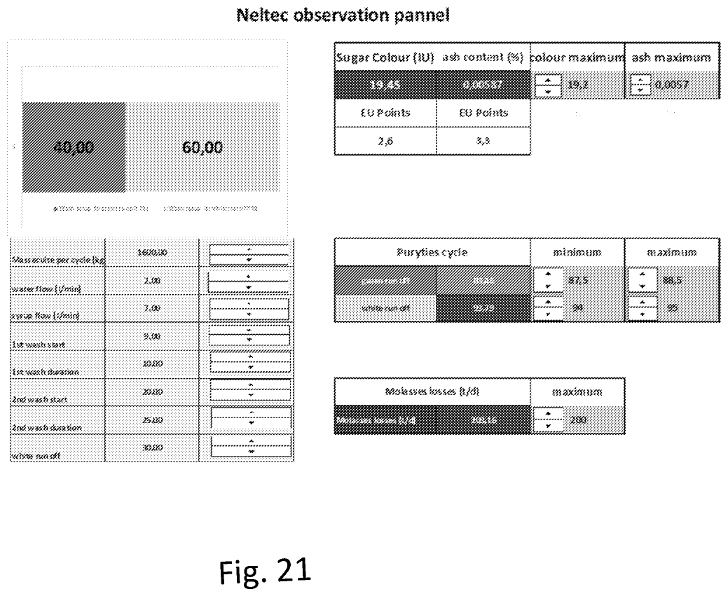

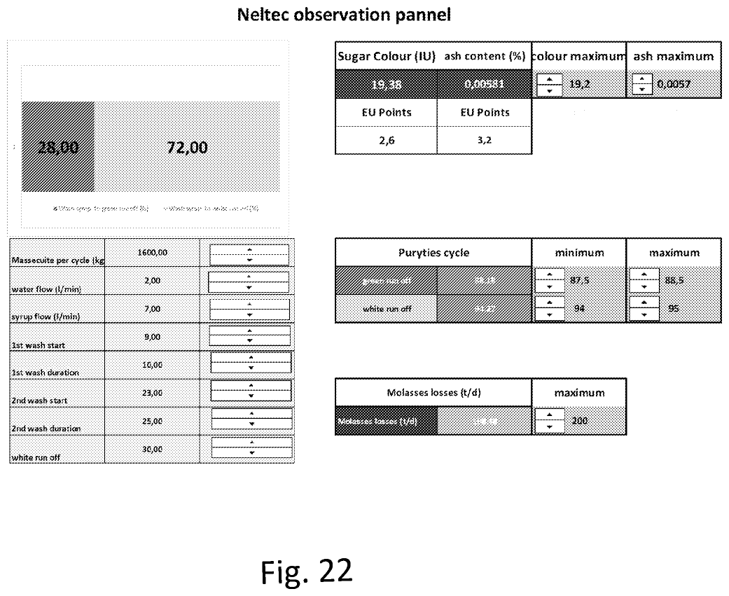

FIG. 21 shows a control panel for the centrifugal according to the present invention. As seen in FIG. 21 important parameters can be changed and observed without influencing the process, since the underlying control program operates on mass balances inside the program, only. In the lower box on the left-hand side in FIG. 21, the operator can change the important centrifugal parameters, in the same way he would do it on site. Above this box is a horizontal pillar/graph which indicates how much of the added wash water is going towards the green run-off (in FIG. 21 this value is 40%) and how much off the water is going towards the white run-off (FIG. 21 this value is 60%). The indicated numbers are showing the percentage distribution of the wash water. To the right of this horizontal pillar/graph, the operator can see the calculated sugar colour and ash content. The sugar factory can set targets for the sugar colour and for the ash content, which are indicated in the fields to the right of the calculated values (colour maximum and ash maximum). To the right of the parameter box, the operator can see the calculated purities for the green run-off and the white run-off, as well as the sugar losses to molasses in tons per day (t/d). For these values also, the sugar factory can provide target points which are indicated in the fields to the right (maximum).

If the calculated values do not match with the target points the values will have a red background colour (not visible in FIG. 21) to indicate an alarm. If the calculated values are within the desired range the background of the values will be green (not visible in FIG. 21).

The example shown in FIG. 21 shows that the wash water starts 20 seconds after the end of the filling of the centrifugal basket. The wash water will be provided for 25 seconds, and 10 seconds after the start of the washing the syrup will change from green run-off to white run-off. This means that the first 10 seconds of the wash water are going to the green run-off, while the last 15 seconds of the run-off are going to the white run-off. This is indicated in the graph showing that 40% of the wash water is going to the green run-off, whereas 60% of the wash water is going to the white run-off.

Almost all important parameters on the right-hand side of the control panel are out of range and therefore indicated in red (not visible in FIG. 21). Only the calculated purity of the green run-off is inside the set range.

FIG. 22 shows the control panel after the operator, or the system itself, has changed the start of the second washing from 20 seconds to 23 seconds. Now only 28% of the wash water is going towards the green-run off, whereas 72% of the wash water is going to the white run-off. The purity of the white run-off thus increases and is now within the set range. The white run-off value is indicated in green (not visible in FIG. 22). Also the daily sugar losses in molasses have been reduced and are now within the set target. The calculated sugar colour and ash content are still too high and out of target.

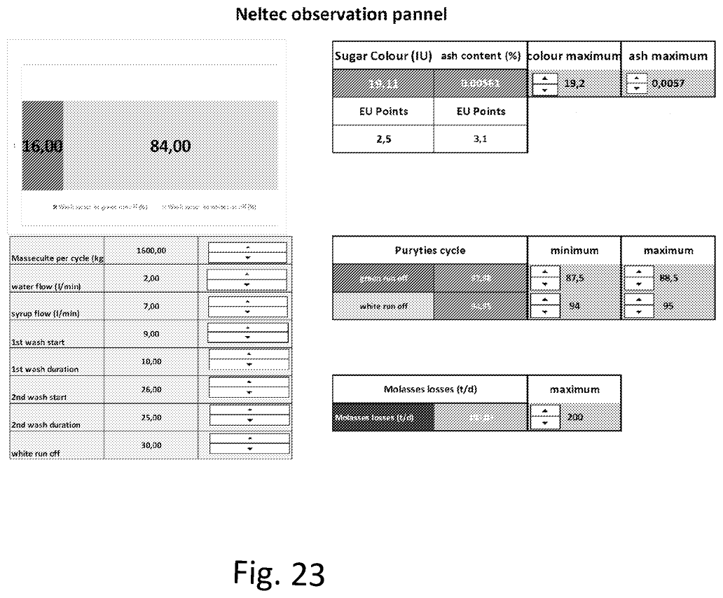

Finally, FIG. 23 shows the control panel after delaying the start of the washing to 26 seconds after the end of filling the centrifugal basket. Now all the parameters shown in the control panel, i.e. sugar colour, ash content, purities cycle (green run-off and white run-off) and molasses losses) are within the set points. The amount of wash water going to the green run-off has been reduced to 16%. The daily sugar losses in molasses have been reduced from 203 tons per day in FIGS. 21 to 195 tons per day in FIG. 23. As all parameters are now within the target values the operator can now change the parameters on the centrifugal panel and thus implement the adjustments in real life. Alternatively, the adjustments can be implemented in real life automatically.

Although the invention has been discussed in the foregoing with reference to exemplary embodiments of the invention, the invention is not restricted to these particular embodiments which can be varied in many ways without departing from the invention. The discussed exemplary embodiments shall therefore not be used to construe the appended claims strictly in accordance therewith. On the contrary, the embodiments are merely intended to explain the wording of the appended claims, without intent to limit the claims to these exemplary embodiments. The scope of protection of the invention shall therefore be construed in accordance with the appended claims only, wherein a possible ambiguity in the wording of the claims shall be resolved using these exemplary embodiments.

1-21. (canceled)

22. A method for controlling separation of solid and liquid phases in a centrifugal basket of a centrifugal, the method comprising the steps of:
determining self-induced vibrations of the centrifugal within a predetermined rotational speed range of the centrifugal basket using an accelerometer,
monitoring at least associated values of the rotational speed of the centrifugal basket and a purging of the liquid phase from the centrifugal basket,
wherein the purging of the liquid phase from the centrifugal basket is monitored using the accelerometer, and
wherein the purging of the liquid phase from the centrifugal basket is monitored while taking into account the determined self-induced vibrations of the centrifugal,
determining a safe temporal range within which temporal range a washing liquid or steam can be safely applied to the content of the centrifugal basket, and
applying a washing liquid or steam to the content of the centrifugal basket during at least a portion of the safe temporal range.

23. The method according to claim 22, wherein the safe temporal range is adapted to begin when a predetermined condition with respect to at least the purging of the liquid phase from the centrifugal basket is met.

24. The method according to claim 23, wherein the predetermined condition with respect to the purging of the liquid phase from the centrifugal basket comprises that the purging rate is essentially decreasing over time.

25. The method according to claim 22, wherein the safe temporal range is adapted to terminate when a predetermined condition with respect to at least a rotational speed of the centrifugal basket is met.

26. The method according to claim 25, wherein the predetermined condition with respect to at least the rotational speed of the centrifugal basket is met when a certain rotational speed of the centrifugal basket is reached.

27. The method according to claim 26, wherein the certain rotational speed of the centrifugal basket is below a given rotational speed.

28. The method according to claim 27, wherein the given rotational speed of the centrifugal basket is around 900 rpm.

29. The method according to claim 22, wherein
a) the rotational speed of the centrifugal basket, during a portion of the safe temporal range, is maintained at an essentially constant speed over a predetermined time interval in order to extend the duration of the safe temporal range, or wherein
b) the rotational acceleration of the centrifugal basket, during a portion of the safe temporal range, is reduced over a predetermined time interval in order to extend the duration of the safe temporal range.

30. The method according to claim 22, further comprising the step of controlling a first controllable valve configured to separate the purged liquid into an impure amount when in a first position, and a pure amount when in a second position.

31. The method according to claim 30, wherein the first controllable valve is switched from the first position to the second position when a predetermined amount of wash water has been applied to the content of the centrifugal basket.

32. The method according to claim 22, wherein the safe temporal range is extended or shortened by varying the rotation speed of the centrifugal basket to obtain an optimal separation of the solid and liquid phases using a predetermined amount of washing liquid or steam.

33. The method according to claim 22, wherein the safe temporal range is extended or shortened by varying the rotation speed of the centrifugal basket to obtain a predetermined separation of the solid and liquid phases using the smallest amount of washing liquid or steam.

34. The method according to claim 22, further comprising the step of reducing the rotational speed of the centrifugal basket if the purging of the liquid phase from the centrifugal basket does not show a decreasing behaviour when the rotational speed of the centrifugal basket has reached a predetermined value.

35. The method according to claim 22, further comprising the step of preventing the application of washing liquid or steam until the purging of the liquid phase from the centrifugal basket shows a decreasing behaviour.

36. A computer program product for carrying out the method according to claim 22 when said computer program product is run on a computer or run on a microprocessor.

37. A centrifugal system for separation of solid and liquid phases, the centrifugal system comprising a centrifugal casing surrounding a centrifugal basket,
wherein a purged liquid from the centrifugal basket hits an interior surface portion of the centrifugal casing, and
wherein an accelerometer is secured to said centrifugal casing, and
wherein the centrifugal system further comprises a control unit for performing the method according to claim 22.

38. A safety procedure method for controlling a centrifugal basket of a centrifugal for separation of solid and liquid phases, the method comprising the steps of:
monitoring at least associated values of the rotational speed of the centrifugal basket and a purging of the liquid phase from the centrifugal basket, and reducing the rotational speed of the centrifugal basket if the purging of the liquid phase from the centrifugal basket does not show a decreasing behaviour when the rotational speed of the centrifugal basket has reached a predetermined value, or
monitoring at least associated values of the rotational speed of the centrifugal basket and a purging of the liquid phase from the centrifugal basket, and reducing the rotational speed of the centrifugal basket if the purging of the liquid phase from the centrifugal basket has not reached a predetermined purging value when the rotational speed of the centrifugal basket has reached a predetermined value.

39. A method according to claim 38, wherein the purging of the liquid phase from the centrifugal basket is monitored using an accelerometer.

40. The method according to claim 38, wherein the predetermined value of the rotational speed of the centrifugal basket is around 500 rpm.

41. The method according to claim 38, wherein the step of reducing the rotational speed of the centrifugal basket comprises the centrifugal basket is brought to a standstill.

42. A computer program product for carrying out the method according to claim 38 when said computer program product is run on a computer or run on a microprocessor.

43. A centrifugal system for separation of solid and liquid phases, the centrifugal system comprising a centrifugal casing surrounding a centrifugal basket,
wherein a purged liquid from the centrifugal basket hits an interior surface portion of the centrifugal casing, and
wherein an accelerometer is secured to said centrifugal casing, and
wherein the centrifugal system further comprises a control unit for performing the method according to claim 38.
